(19) United States
(12) Patent Application Publication
(10) Pub. No.: US 2023/0307898 A1
(43) Pub. Date: Sep. 28, 2023

(54) SWITCH PLATE COVER DEVICE

(71) Applicant: Blake Smith, Bradley, IL (US)

(72) Inventor: Blake Smith, Bradley, IL (US)

(21) Appl. No.: 17/703,069

(22) Filed: Mar. 24, 2022

(51) Int. Cl. H02G 3/14; H01H 9/18

(52) U.S. Cl. CPC H02G 3/14; H01H 9/18

(57) ABSTRACT

A switch plate cover device is provided. The device provides a functional and artistic surround to an existing switch plate cover assembly. The device is fashioned for insertion beneath an existing wall plate. A recessed inner lip of the device is adapted for positioning beneath an existing wall plate, the inner lip serving to cover any gaps between the existing wall plate and the wall, while also serving to lock the device in place beneath and around the wall plate. The device can effectively repair any gaps between the wall plate and the wall.

### FIELD OF THE INVENTION

The present invention relates generally to wall and switch plate hardware. More particularly, the invention relates to a switch plate cover device that can be used as a switch plate surround.

### BACKGROUND OF THE INVENTION

Ever since the advent of electrical power grids, it has been essential to safely switch and provide access to AC power within the home or office environment. To that end, both wall switches and outlets must have protective hardware coverings to prevent incidental contact with conducting wires and terminals. A standard switch plate assembly includes a rigid planar member having openings sized for the protrusion of switches or receptacle components therethrough. One or more screw holes are formed in the planar member to allow for screws to be inserted therein to fasten the member to the wall and complete the assembly. A common problem with wall and switch outlets is that the surrounding opening in the drywall or plaster may be too large or irregular so that there is a portion of opening not covered by the rigid planar member. This is both unsightly and a safety hazard. The only way of dealing with this problem in the past has been to repair the surrounding drywall or plaster after removing the plate. This type of repair typically cannot be done by the average homeowner.

Many switch plate covers are designed with aesthetic features or images, and may be selected to compliment the decor. These covers need to be removed when the decor changes.

### SUMMARY OF THE INVENTION

A switch plate cover device is provided. The device provides a functional and artistic surround to an existing switch plate cover assembly. The device is fashioned for insertion beneath an existing wall plate. A recessed inner lip of the device is adapted for positioning beneath an existing wall plate, the inner lip serving to cover any gaps between the existing wall plate and the wall, while also serving to lock the device in place beneath and around the wall plate. The device can effectively repair any gaps between the wall plate and the wall.

It is a major object of the invention to provide a switch plate cover device.

It is another object of the invention to provide a switch plate cover device that can be used with an existing switch plate cover assembly.

It is another object of the invention to provide a switch plate cover device that can be used to repair drywall damage surrounding the electrical box.

It is another object of the invention to provide a switch plate cover device that can be used as a switch plate surround.

### BRIEF DESCRIPTION OF THE DRAWINGS

FIG. 1 is an exploded perspective view of the device of the invention in its intended environment.

FIG. 2 is a plan view of the device of the invention used with an electrical outlet.

FIG. 3 is a plan view of the device of the invention used with a wall switch plate.

### DETAILED DESCRIPTION

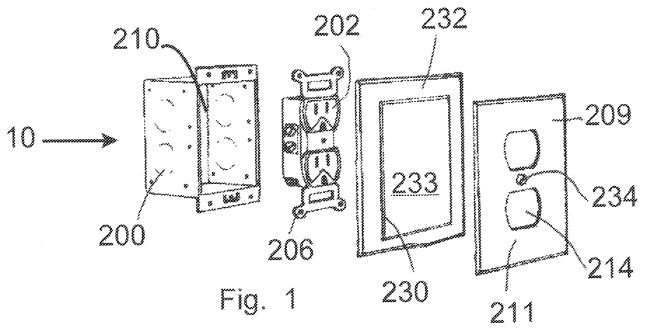

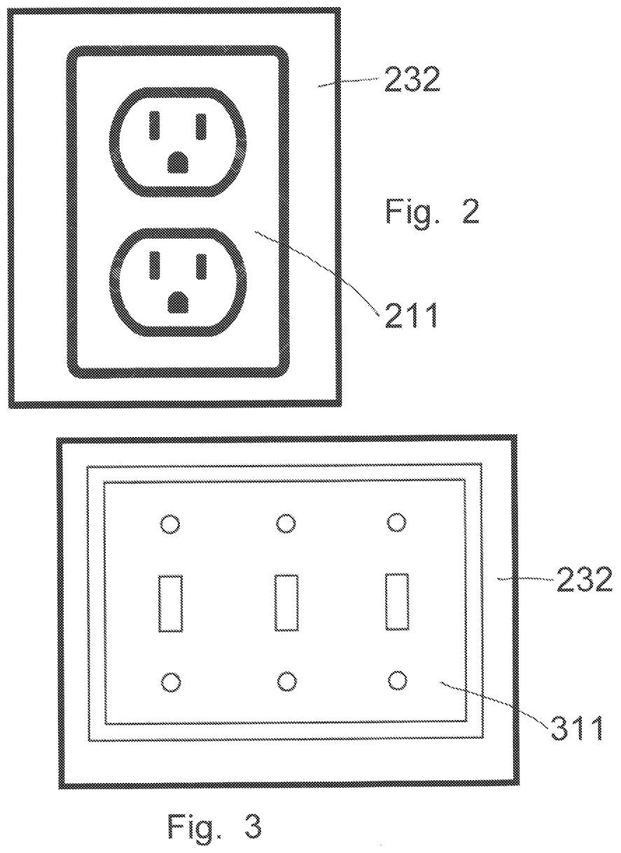

Referring now to FIGS. 1-3, the present invention is directed to a cover plate device 10 for use in connection with an electrical box 200. The electrical box 200 is an electrical junction location that provides various electrical services to the consumer. For example, the electrical box 200 may be a switchbox, an outlet box, an electrical utility box, a combined switch and outlet box, etc. As is known in the art, the electrical box 200 would include various electrical appurtenances 202 that are associated therewith. For example, the electrical appurtenance 202 may be a switch, an outlet 206, a knob, etc. Again, as is known in the art, the switch would be used to turn the electricity on and off, for example, turning the lights on and off. The outlet 206 would be used to plug various electrical devices into the electrical box 200. The knob would be used to provide thermostat or adjustable control of various electrical devices. While shown as a cover plate for a single switch or pair of outlets, it can be appreciated that the device 10 could be expanded for use with multiple switch outlets or switches like cover plate 311 shown in FIG. 3.

The electrical box 200 includes a cover plate assembly that has a plate element 211 that is attachable to or at least partially covers a side 210 of the electrical box 200. In addition, the plate element 211 includes at least one, and typically multiple, electrical box orifices 214 that permit access to the electrical appurtenances 202 of the electrical box 200. Therefore, the electrical box orifices 214 are configured to allow access to an outlet 206, switch, knob, etc.

The device 10 has both utilitarian and aesthetic uses. The opening formed in the wall for an electrical box 200 is typically formed by a worker that is tasked with making many of the openings in a single day. Accordingly, it is often the case that the opening is not uniform with respect to its boundaries and thus even when plate element 211 is in place, there is a gap. The gap is both unsightly and dangerous, as electrically conducting parts of the box may be accidentally contacted by people or pets. A typical repair involves removing the plate 211, and fixing the drywall/plaster with spackle or other material. This type of repair is not easily done by homeowners. The relatively wide border 232 of the device 10 allows it to cover any other wall issues out to its periphery. The width of border 232 also allows for the positioning of both aesthetic and functional features thereon. For example, for a sight impaired person braille characters may be positioned thereon, the characters containing information about, e.g., the device connected to the electrical box 200. In the event that there are multiple switches as shown in FIG. 3, indicia such as lettering, decals, braille characters, etc. may positioned or printed on border 232. The border 232 may also provide a writing surface for handwritten indicia.

The invention allows homeowners to make a quick repair without the need for any specialized tools, expertise, or materials. Also if the e.g., homeowner, decides to replace the existing wall plates for any reason, he has to deal with the expense of buying all new plates. The present invention allows the user to get an aesthetic upgrade without replacing the plates 211, the devices themselves 10 being cheaper than the plates 211. In order to attach the device 10 to the electrical box 200, the device includes a securing mechanism in the form of an inwardly protruding lip 230. The lip 230 extends at least ⅛ inch inward from the border 232, and is thin relative to the border 232 so as to slide under plate 211. The device 10 is sized so that the opening 233 formed by the lip is slightly smaller than the dimensions of cover plate 211.

In use, the user simply removes the screw 234 holding plates 211 onto the electrical box, and positions the device 10 between the plate 211 and box 200 as shown in FIG. 1. The screw 234 is then reinserted and screwed in until the device 10 and cover plate 211 are pressed together, with lip 230 essentially providing a seal. The user may put indicia on the border as described above.

It is to be understood that the present invention is not limited to the sole embodiment described above, but encompasses any and all embodiments within the scope of the following claims:

I claim:

1. A device for use with an electrical box having an open side and a cover plate comprising:
a substantially planar, generally rectangular main body surround having an opening formed therein, an inner boundary of the surround formed as a lip;
said lip formed of a thinner material than the surround, said surround positioned between said cover plate and said open side when the device is installed.

2. The device of claim 1 wherein said surround includes a border area around said cover plate.

3. The device of claim 2 wherein said border area includes indicia.

4. The device of claim 3 wherein said indicia is braille.

5. The device of claim 3 wherein said indicia is one or more decals.
